(19) United States
(12) Patent Application Publication
(10) Pub. No.: US 2010/0064908 A1
(43) Pub. Date: Mar. 18, 2010

(54) PRESS ASSEMBLY FOR FIBROUS MATERIALS

(76) Inventor: CURTIS THOMAS CURLES, Cordele, GA (US)

Correspondence Address: Nelson Mullins Riley & Scarborough LLP;IP Department, 100 North Tryon Street, 42nd Floor, Charlotte, NC, 28202-4000, US

(21) Appl. No.: 12/562,817

(22) Filed: Sep. 18, 2009

Related U.S. Application Data
(60) Provisional application No. 61/098,023, filed on Sep. 18, 2008.

(51) Int. Cl. B30B 7/04; B30B 15/32

(52) U.S. Cl. 100/209; 100/42; 100/218

(57) ABSTRACT

A press assembly for fibrous substance including a tramper assembly with a tramping chamber and a tramper, the tramper being movable along a length of the tramping chamber, and a main compressor including a main compression box and a follow block, the follow block being movable along a length of the main compression box. The tramping chamber and the main compression box are in communication with each other such that fibrous substances disposed within the tramping chamber can pass directly from the tramping chamber to the main compression box

### CLAIM OF PRIORITY

This application claims priority to U.S. Provisional Patent Application Ser. No. 61/098,023, filed Sep. 18, 2008, the entire disclosure of which is incorporated by reference herein.

### FIELD OF THE INVENTION

The present invention relates generally to a press assembly for fibrous substances. More particularly, the present invention relates to a press for use in baling loose cotton.

### BACKGROUND

Most fiber presses in use today are double box presses. While a first box is vertically packed with fiber utilizing multiple strokes to a low density (tramping), a second box is vertically packed utilizing one stroke of a ram to a much higher density, making a bale. This type of press is comprised of two boxes mounted on a large turntable, which rotates 180 degrees to place the contents of the boxes below the tramper or the ram alternately. Obviously, it takes a large machine to accomplish this task. As well, the higher the production rate requirement, the faster the turntable must rotate. As would be expected, there are numerous safety concerns during rotation of the turntable and typical installations have nothing more than an alarm to warn laborers of the impending danger.

The present invention recognizes and addresses the foregoing considerations, and others, of prior art constructions and methods.

### SUMMARY OF THE INVENTION

One embodiment of the invention is a press assembly for a fibrous substance, comprising a tramper assembly including a tramping chamber and a tramper, the tramper being movable along a length of the tramping chamber, and a main compressor including a main compression box and a follow block, the follow block being movable along a length of the main compression box. The tramping chamber and the main compression box are in communication with each other such that the fibrous substance disposed within the tramping chamber can pass directly from the tramping chamber to the main compression box.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIGS. 1A through 1C are side, front and a partial top view of a press assembly in accordance with an embodiment of the present invention;

FIGS. 2A through 2J are side views showing sequential steps in the operation of the press assembly as shown in FIGS. 1A through 1C;

FIGS. 3A through 3E are various views of the components of a chain drive of the press assembly as shown in FIGS. 1A through 1C; and

FIGS. 4A through 4C are side, FIG. 4A, and cross-sectional views, FIG. 4B being along line 4B-4B of FIG. 4A and FIG. 4C being taken along line 4C-4C of FIG. 4A, of a seal arrangement of the press assembly as shown in FIGS. 1A through 1C.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

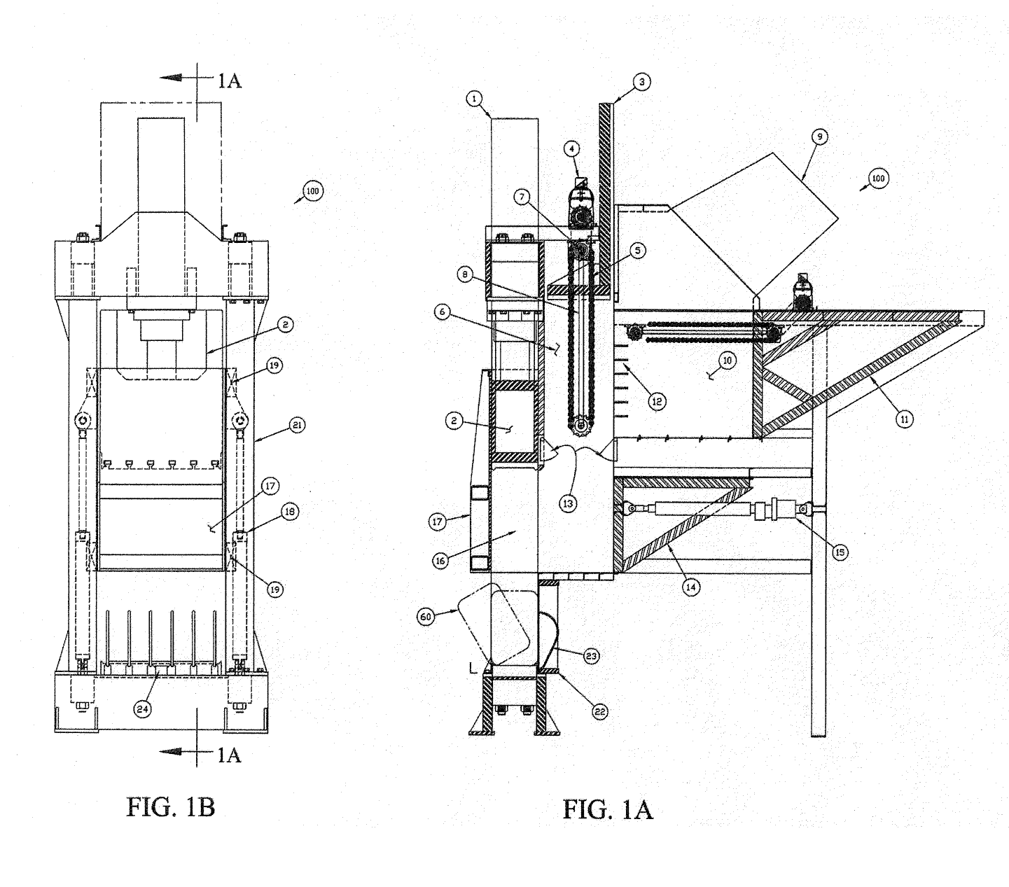

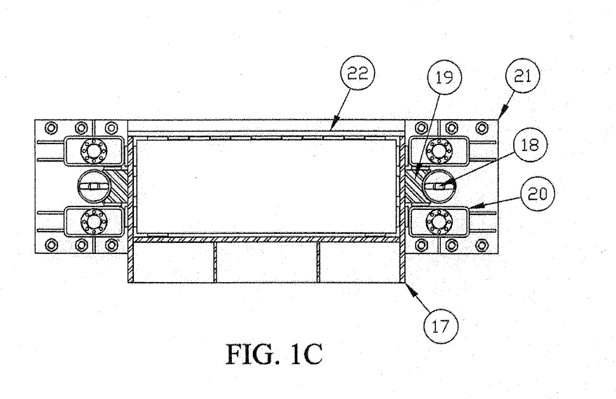

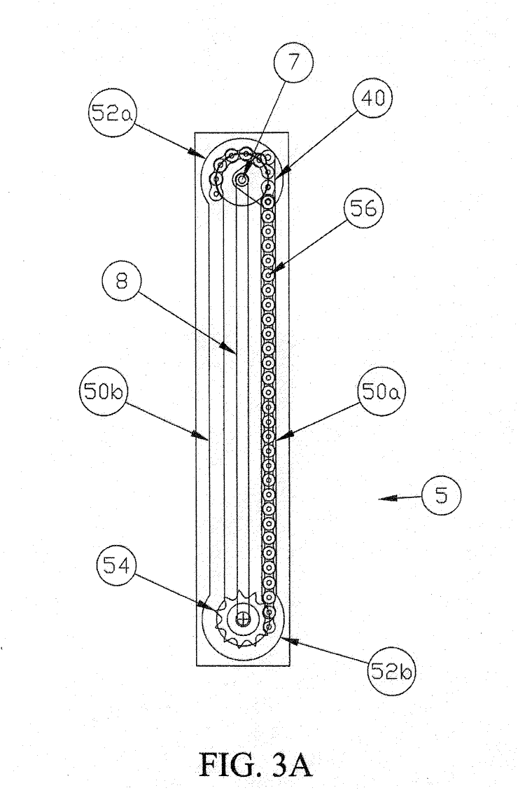

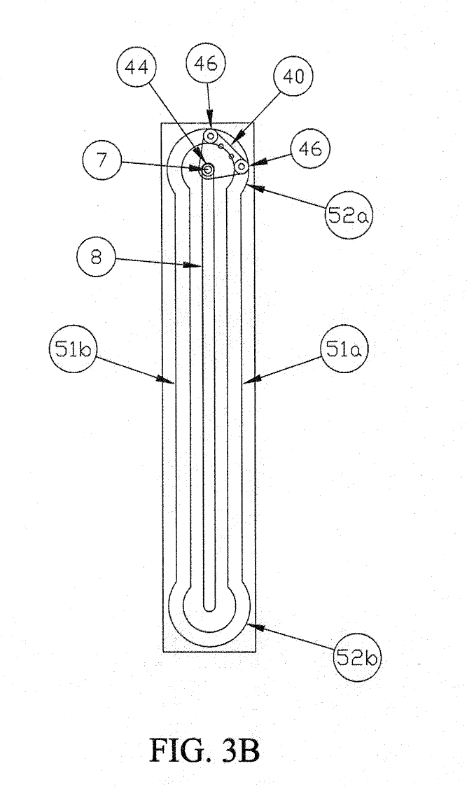

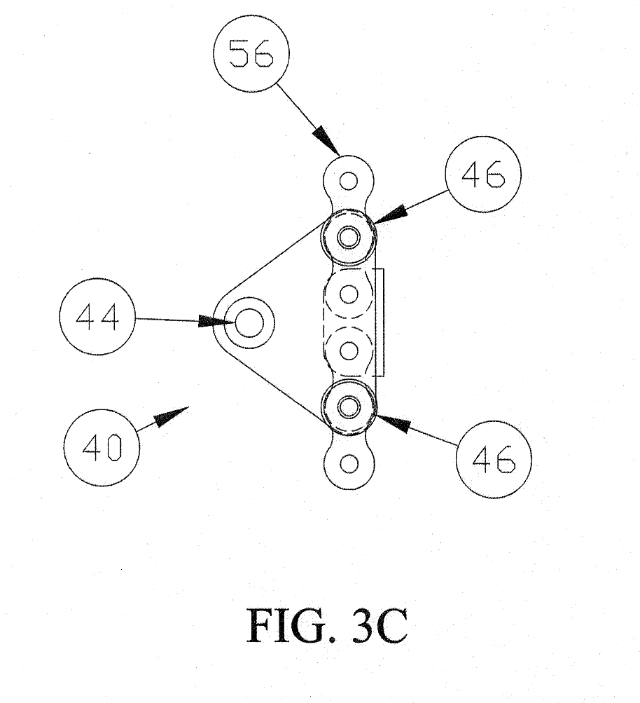

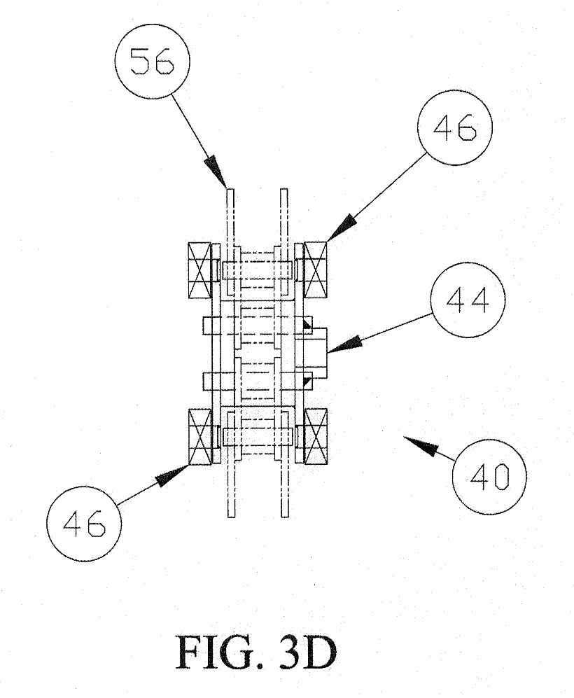

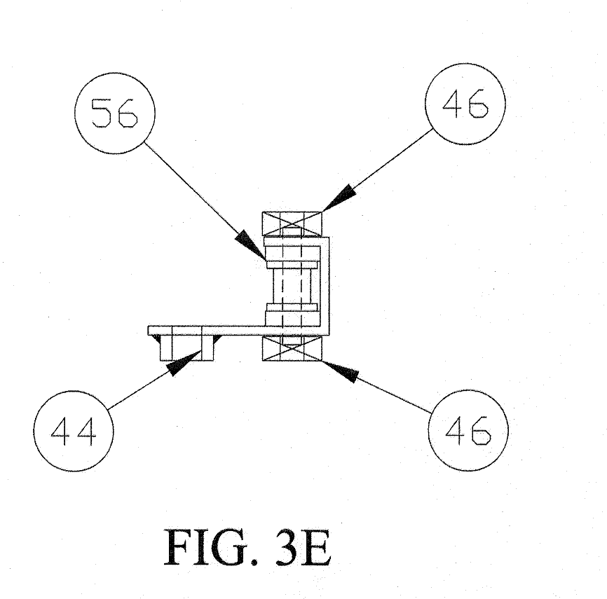

Referring now to FIGS. 1A through 1C, a press assembly 100 in accordance with a preferred embodiment of the present invention is shown. Note, a portion of the side of the press assembly 100 is removed so that various internal components are visible. The press assembly 100, as shown, includes a main ram hydraulic cylinder 1 connected to a follow block 2. Both the main ram hydraulic cylinder 1 and the follow block 2 are mounted vertically and are used to compress low density fibers (not shown) into higher density bales 60. In line and adjacent to the main ram is a tramper 3 which is driven by a gear motor 4 and a chain drive 5 (FIGS. 3A through 3E) mounted externally on either side of the tramping chamber 6. The tramper 3 is connected to the chain drive 5 via a horizontal round shaft 7. The round shaft 7 protrudes outwardly from the tramping chamber 6 through a vertical slot 8. The round shaft 7 is connected to the chain drive 5 via a side link 40 (FIG. 3A) that cooperates with a track 50a, 50b, 52a and 52b (FIG. 3A) to prevent lateral motion of the tramper 3 relative to the slot 8 as the tramper 3 travels along the slot 8 longitudinally. The tramper 3 and pusher 11 chain drive systems incorporate a feature that causes a pause at the ends of each stroke. The pause is created as the side link 40 rotates around the sprockets 54. Side link 40 is designed such that the pull point, or aperture 44, to which the round shaft 7 is mounted, is on the centerline of the sprocket 54, as the side link 40 rotates around the sprockets 54. As such, little to no lateral motion of the round shaft 7 occurs relative to the slot 8. Note, the side link 40 includes a pair of cam followers 46 that ride in substantially circular end portions 52a and 52b of the track as the side link 40 rotates about the sprockets 54, and in the parallel side portion 50a and 50b in between. This can be particularly helpful when stopping at the end of either stroke. This design allows 180 degrees of rotation tolerance to stop within.

Adjacent and inline with the tramping chamber 6 is a pusher box 10 that includes an infeed hopper 9 to allow loose fibers to be loaded into the pusher box 10, as needed. A pusher 11 is used to compress the loose fibers horizontally until the loose fibers enter the tramping chamber 6. The pusher 11 is driven by a chain drive 5 like the one previously described with regard to the tramper 3 and shown in FIGS. 3A through 3E. Side dogs 12 hold the fibers inside the tramper chamber 6 as the pusher 11 is retracted so that an additional amount of loose fibers can be added to the pusher box 10 and compressed into the tramping chamber 6 by the pusher 11. Vertical dogs 13 hold the fibers down as the tramper 3 packs the desired amount of fibers for the bale 60. Note, the enclosed chain driven tramper 3 and pusher 11 provide smooth electric motor control, thus allowing programming options that enable the press assembly 100 to react on demand to changing production conditions. The tramper 3 and the pusher 11 can be tuned for increased performance resulting in higher overall efficiency than may exist with known systems. As well, less dependence on hydraulics minimizes power unit size and results in far less leaks.

An indexing ram 14 is driven by an electric cylinder 15 and is used to move the charge of tramped fibers from below the tramper 3 into a main compression box 16 and below the follow block 2 of the main ram hydraulic cylinder 1. Note, the tramping chamber 6 dimensions are not restricted in horizontal depth to the main compression box 16 dimensions because the boxes are adjacent, thus allowing larger charges of fibers in the tramping chamber 6 than in known fiber presses.

A three sided lift box 17 is raised and lowered by two lift box hydraulic cylinders 18. The three sided lift box 17 includes four guides 19 that are positioned between rectangular tubes 20 of the vertical column fabrications 21. The vertical column design provides guidance to the three sided lift box 17 while at the same time providing the necessary structural support needed to resist the swelling forces of the fibers generated during compression. A back wall of press 22 is stationary and provides the fourth wall required during bale formation. The back wall is fitted with chutes 23 for guiding wire tires during manual strap placement from the exit side of the press assembly 100. A hydraulic bale ejector 24 is provided to tilt the bale 60 out of the press assembly 100 onto a customer provided take-a-way system.

### Operation

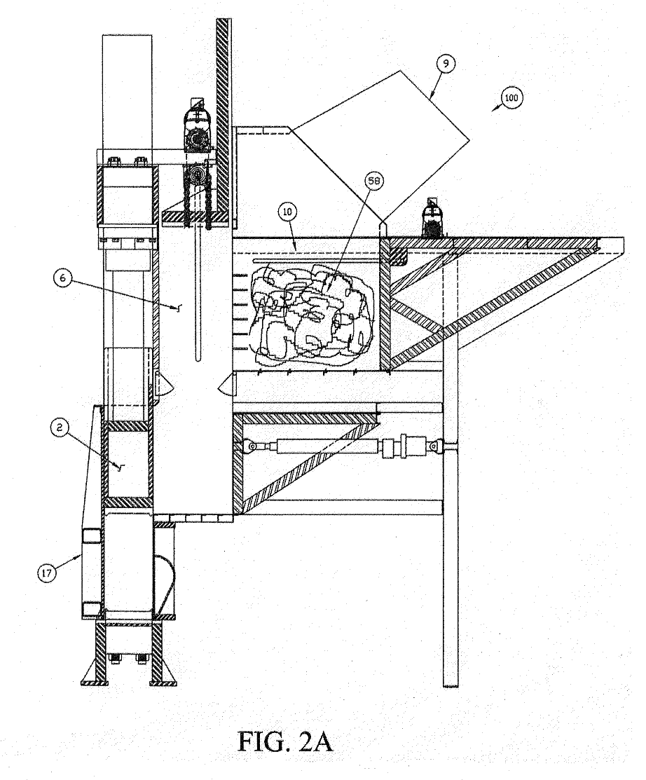

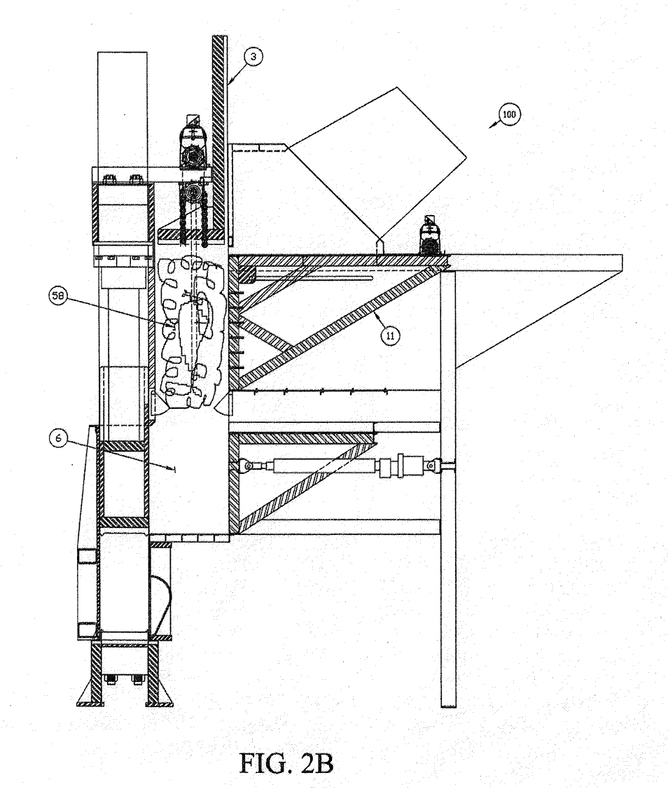

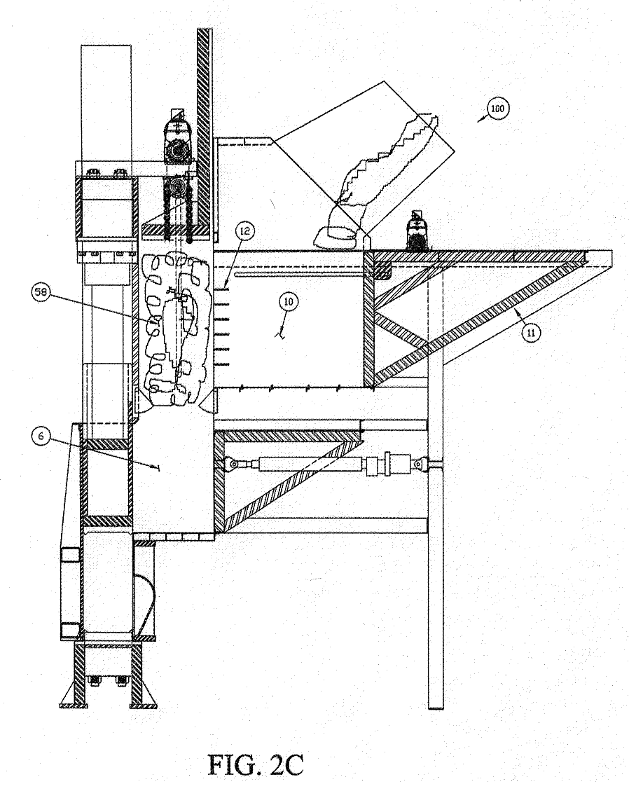

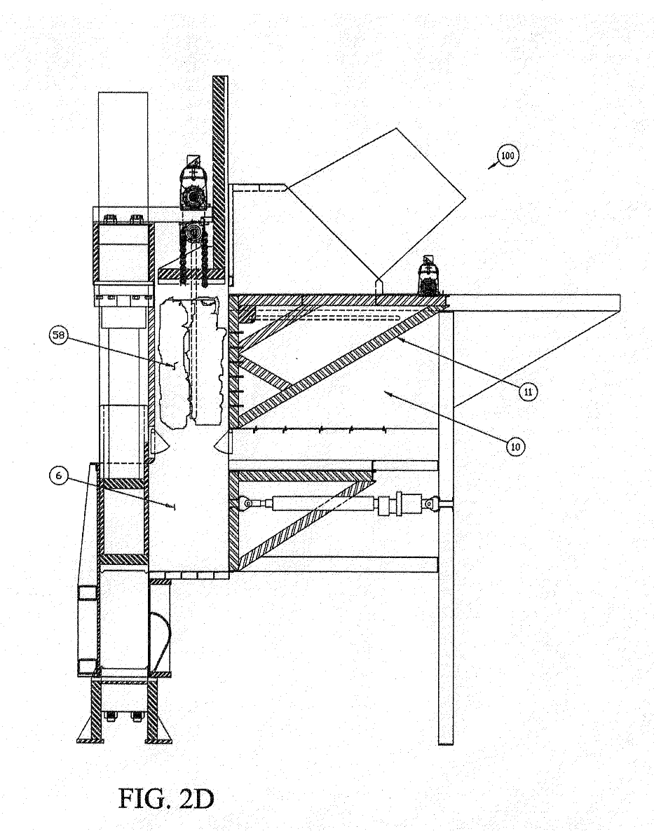

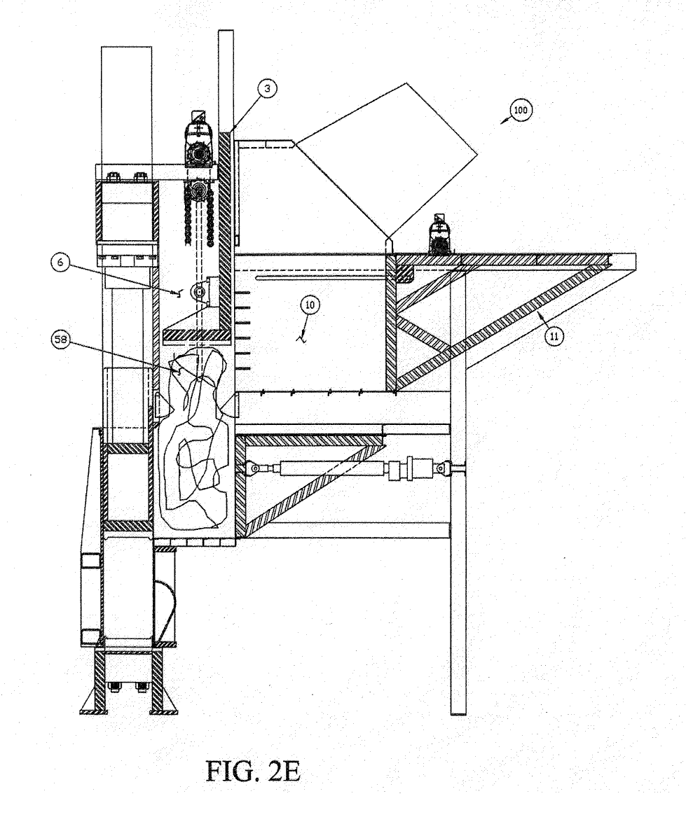

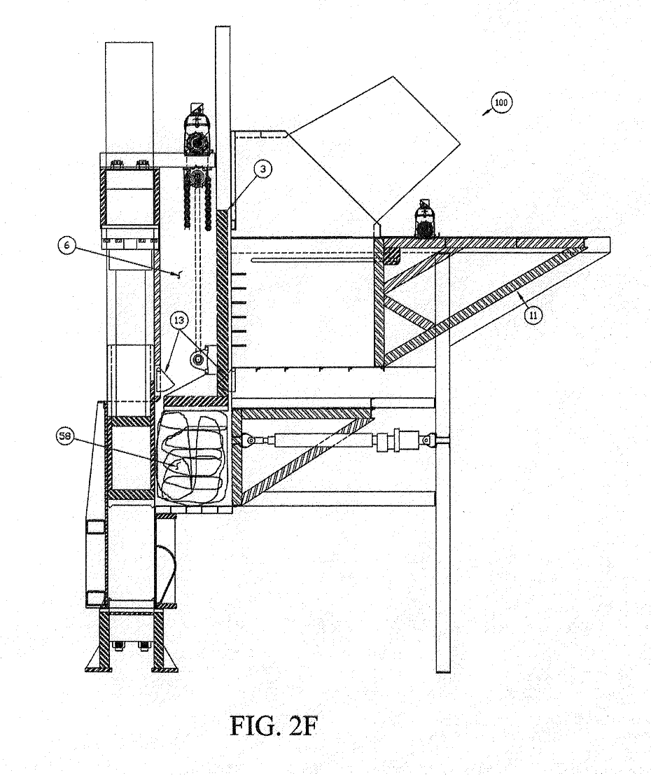

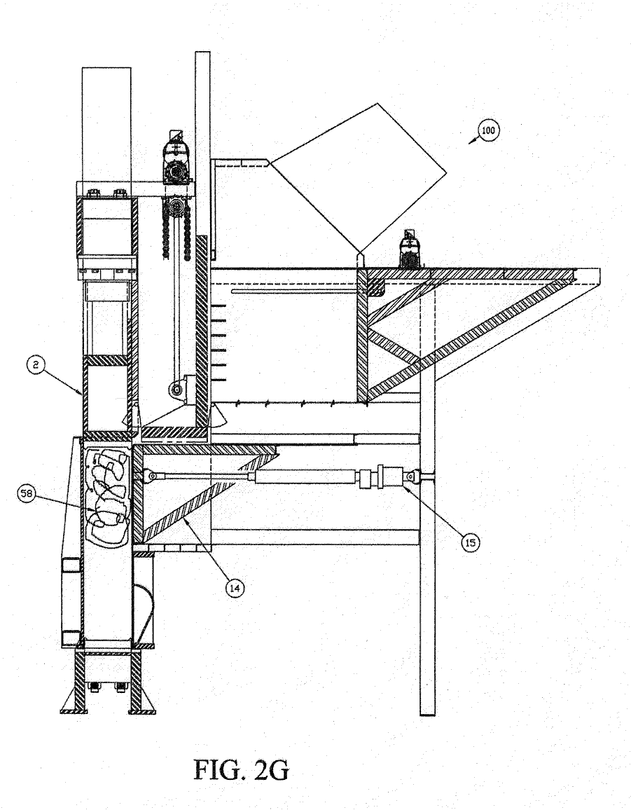

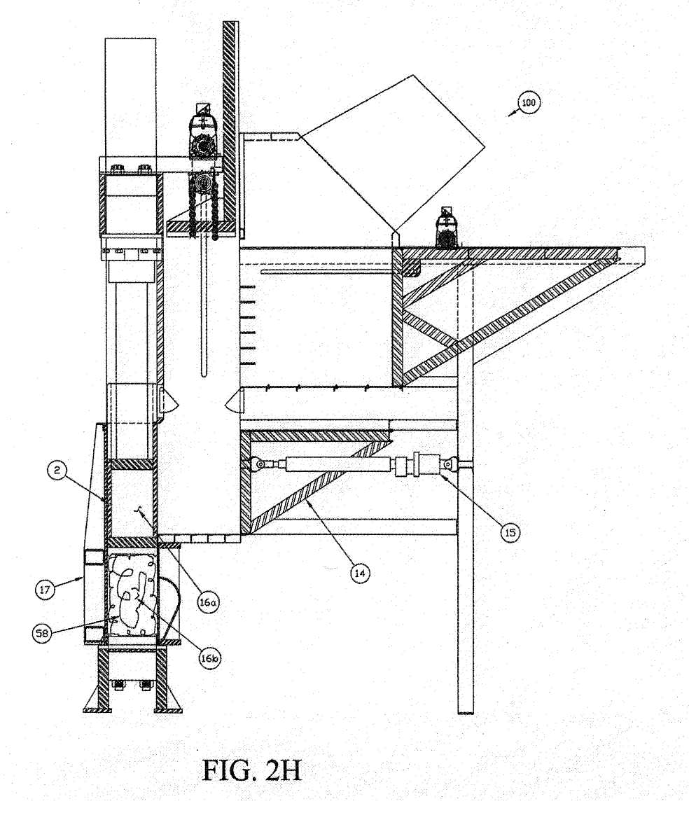

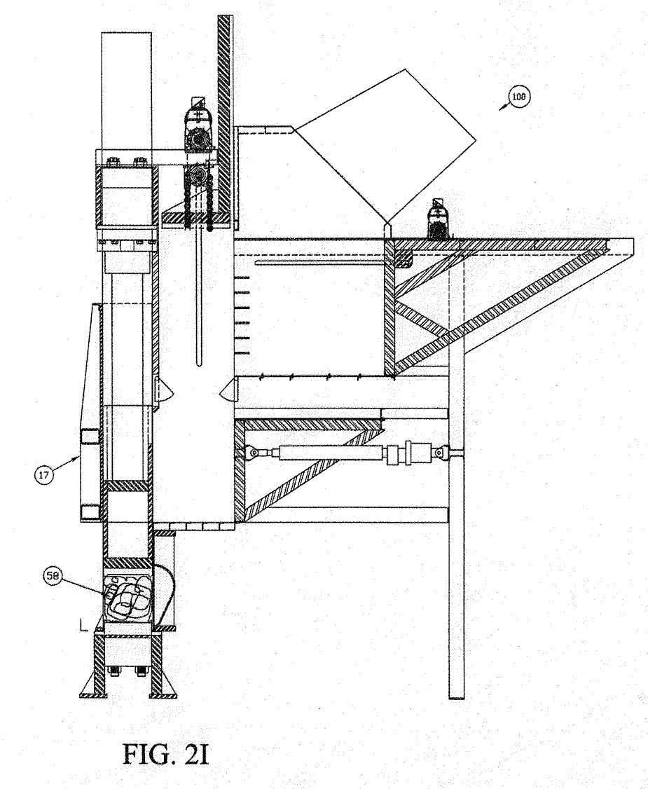

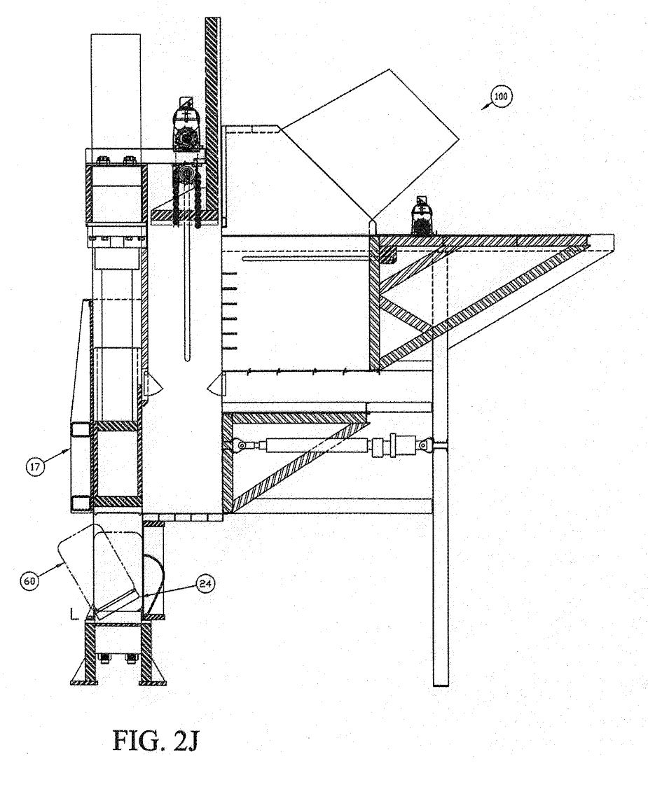

Referring now to FIGS. 2A through 2J, the use of the press assembly 100 to form a bale 60 from a loose fibrous substance is discussed. The sequence begins as shown in FIG. 2A, with the bottom of the follow block 2 positioned adjacent the bottom of the tramping chamber 6 and with the lift box 17 in the full down position. Loose fibers 58 are put into pusher box 10 through infeed hopper 9 as shown in FIG. 2A. As shown in FIG. 2B, the pusher 11 advances transferring and horizontally compressing the fibers into and below tramper chamber 6. As shown in FIG. 2C, the pusher 11 is retracted and the horizontal side dogs 12 prevent the compressed fibers 58 from expanding back into the pusher box 10. Additional loose fibers can now be loaded into the pusher box 10. As shown in FIG. 2D, when the pusher box 10 is full, the pusher 11 advances again doubling the density of the total fiber charge.

As shown in FIG. 2E, upon completion of second forward stroke of the pusher 11, the tramper 3 starts downward and as the tramper 3 reaches mid-stroke, the pusher 11 is retracted to the open position so the pusher box 10 can start being refilled with loose fibers. As shown in FIG. 2F, the tramper 3 continues downward until the tramper 3 is below the vertical dogs 13, and then returned to the full up position. Just before the tramper 3 reaches the full up position, the pusher 11 advances twice and the tramper 3 strokes down and up again. This process continues until the tramper 3 motor load control reaches a set point established by the customer that correlates to the desired bale weight. On the last downward stroke, the tramper 3 stops at full down position.

As shown in FIG. 2G, the follow block 2 raises to the full up position and the indexing ram 14 advances the fiber charge below the follow block 2. As shown in FIG. 2H, the follow block 2 advances to move the fiber charge from the upper main compression box 16a to lower main compression box 16b with the indexing ram 14 forward, and when the bottom of the follow block 2 reaches the bottom of tramping chamber 6 floor, the indexing ram 14 retracts and stops. The tramper 3 and the pusher 11 can now resume activity. The follow block 2 continues downward until reaching 30-36 inches of separation from the bottom of the main compression box 16. As shown in FIG. 2I, the lift box cylinders 18 (FIG. 1B) extend to strip the lift box 17 upward and stop at the full up position. The follow block 2 continues downward to fully compress the fiber charge. When desired final platen separation is obtained, a bale complete alarm sounds and the bale 60 can be manually or automatically strapped.

As shown in FIG. 2J, after the bale 60 is strapped, the follow block 2 is raised to the bottom floor of the tramping chamber 6 and stops. The bale 60 expands to tighten straps as the main ram hydraulic cylinder 1 raises. After strapping, the bale 60 is ejected onto bale take-a-way system (not shown) by the bale ejector 24. The bale ejector 24 returns to the home position and the lift box 17 is returned to the full down position. When the lift box 17 is fully down, another total charge will be nearing completion and the sequence begins again as the tramper motor load control reaches the set point.

While it is understood that programming is subject to many sequential improvements, one feature not mentioned in the sequence description is the incorporation of one stroke of the pusher at the beginning of each baling cycle. This helps clear the fiber slide and will also be used at the end of each baling cycle to achieve accurate bale weights. Another such improvement is a graduated main ram retract sequence that enables the follow block 2 to move upward as tramping chamber 6 is filled. The sequence will start when the tramped fibers are stable enough not to bulge into the upper main ram compression chamber. This sequence will reduce the indexing time from tramping chamber 6 needed on high production models.

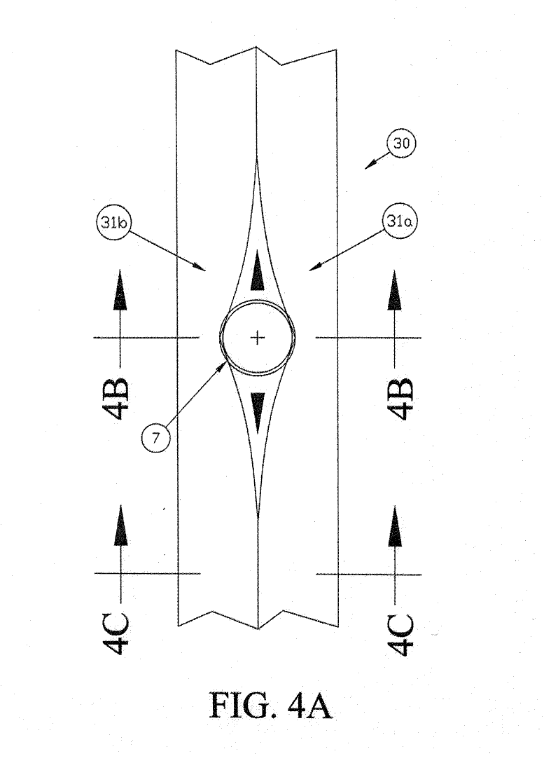

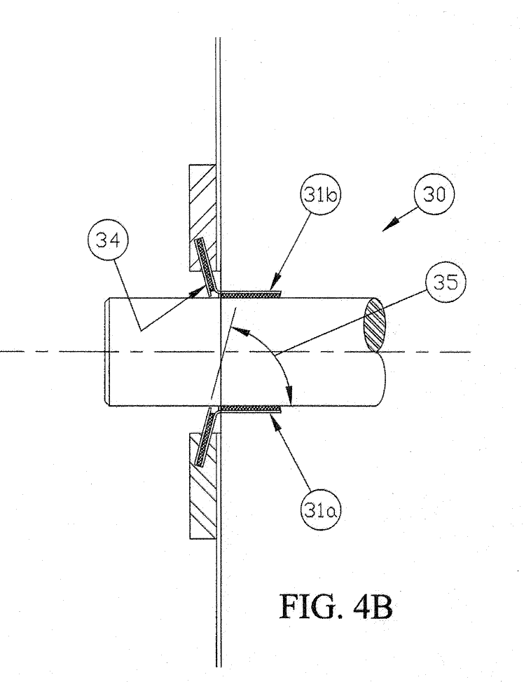

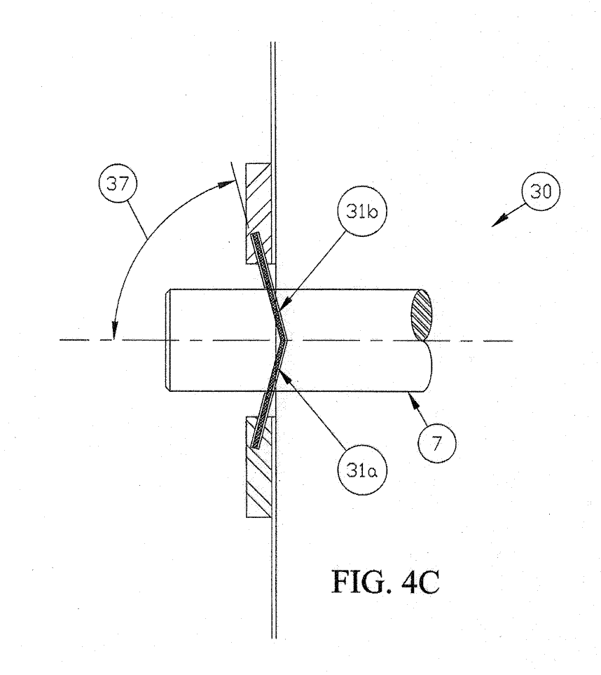

FIGS. 4A through 4C show a seal arrangement 30 that is self-locking. The seal arrangement 30 is to be used on both the tramping chamber 6 and the pusher box 10 to close the longitudinal slots necessary to connect to the chain drive 5 shown in FIGS. 3A through 3E. It is desirable to close the slot in order to prevent fibers or similar product from blowing out of the slot during compression. The seal arrangement 30 is “unzipped,” or opened, as the round connection shaft 7 of the side link 40 runs parallel to the slit between the seal halves 31a and 31b. The seal halves 31a and 31b are made of at least two layers, both chosen for different reasons. The outer layer is pliable such that the seal halves 31a and 31b can deflect and conform to the shape of the round shaft 7 preferably, the outer layer is elastic enough to stretch through an angle 35 at least 75°. The inner layer is pliable such that the seal halves 31a and 31b can deflect and conform to the shape of the round shaft 7, but are also rigid enough not to buckle in the closed position, FIG. 4C. Preferably, the seal arrangement 30 is installed at an angle 37 that is 75° to the axis of the round shaft 7 so that the seal halves 31a and 31b lock against each other as product builds pressure from inside of the compression chamber. A metal retainer 34 assures that the seal halves 31a and 31b return to the locked position and not beyond with the seal halves 31a and 31b overlapped.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed:

1. A press assembly for a fibrous substance, comprising:
a tramper assembly including a tramping chamber and a tramper, the tramper being movable along a length of the tramping chamber; and
a main compressor including a main compression box and a follow block, the follow block being movable along a length of the main compression box,
wherein the tramping chamber and the main compression box are in communication with each other such that fibrous substances disposed within the tramping chamber can pass directly from the tramping chamber to the main compression box.

2. The press assembly of claim 1, further comprising a chain drive system configured to move the tramper along the length of the tramping chamber.

3. The press assembly of claim 1, further comprising a hydraulic cylinder configured to move the follow block along the length of the main compression box.
